(19) United States
(12) Patent Application Publication
(10) Pub. No.: US 2026/0235432 A1
(43) Pub. Date: Aug. 13, 2026

(54) METHOD FOR DEFINING A FILLING LEVEL MEASUREMENT RANGE

(71) Applicant: Endress+Hauser SE+Co. KG, Maulburg (DE)

(72) Inventors: Philipp Höre, Freiburg (DE); Manuel Sautermeister, Schopfheim (DE); Junaid Ali Shah, Steinen (DE); Marco Suevo, Todtnau (DE)

(21) Appl. No.: 19/155,449

(22) PCT Filed: Jan. 26, 2024
(86) PCT No.: PCT/EP2024/051890

§ 371 Date: Aug. 11, 2025

(30) Foreign Application Priority Data
Feb. 10, 2023 (DE) 10 2023 103 244.5

(51) Int. Cl. G01F 23/284; G01F 23/2962

(52) U.S. Cl. CPC G01F 23/284; G01F 23/2962

(57) ABSTRACT

A method for defining a fill level measurement range for travel time-based measurement of fill levels in containers includes placing a travel time-based, fill level measuring device at the upper end region of a container and measuring the distance to the container floor in the case of empty container such that the fill level measurement range is defined both relatively and absolutely, in that the limits of the measuring range are determined based on the measured distance value. Defined as lower limit is the measured distance value. In the case of a relative measuring range, the upper measuring range limit is defined by multiplying the measured distance value by an earlier determined factor of maximum 1. Advantageous in the method is that the fill level measuring device can be used without calibration and without knowledge of the geometry in the interior of the container.

The invention relates to a method, by means of which a relative or absolute fill level measurement range is defined, in order to determine corresponding fill level values of fill substances in containers by means of travel time-based measurement.

In process automation technology, various types of field devices are applied for registering process parameters of interest. Implemented for this in the various types of field devices are suitable measuring principles, with which process parameters, such as fill level, flow, pressure, temperature, pH value, redox potential and conductivity, are registrable. The most varied of such field devices-types are manufactured and sold by the “Endress+Hauser” group of firms.

For fill level measurement of fill substances in containers, travel time-based measurement principles have proven themselves, since they are robust and permit a contactless measuring. In such case, the measuring principle of travel time measurement is based either on freely emitted, high frequency signals, especially radar or ultrasound, or on guided radiation of high frequency signals, such as in TDR (“Time Domain Reflectometry”). In the case of freely radiating radar, mainly the FMCW (“Frequency Modulated Continuous Wave”) method is used. The less frequently implemented, pulse travel time method is applied mainly in ultrasonically based fill level measuring devices.

Travel time-based, fill level measurement is well known in the state of the art, in the case of FMCW-radar based, fill level measurement, for example, from publication DE 102013108490 A1. Travel time-based fill level measuring devices have in common that the vertical distance from an upper end region in the container to the surface of the fill substance is measured via the signal travel time of a high frequency signal reflected on the surface. By means of the registered signal travel time, the fill level of the fill substance in the container can then be ascertained by taking the container geometry into consideration. In such case, the container geometry must be configured specific to the customer or application in the fill level measuring device. Such can occur, for example, in the form of manual input of key geometric data, for example, the distance of the fill level measuring device from the floor of the container. Manual input is possible, for example, via suitable software tools, such as smart phone apps, via the interface of the process control station, or via a display menu of the fill level measuring device. However, this lessens the effort during start-up of the fill level measuring device on the container only to a certain degree.

It is, consequently, an object of the invention to provide a fill level measuring device, which can be easily placed in operation on the container.

The invention achieves this object by a method for defining a fill level measurement range for travel time-based measuring of a relative or absolute fill level value of a fill substance in a container. For this, the method includes method steps as follows:
placing a travel time-based, fill level measuring device at an upper end region of the container, wherein it is assured that the container is completely empty,
travel time-based measuring of a distance to the floor of the container, and
defining the fill level measurement range, in that the fill level value of zero (percent) is defined based on the measured distance value.

In such case, the distance value measured in the case of empty container can either be defined directly as fill level value of 0 (percent), or this distance value is corrected by a defined offset, wherein the corrected distance value is defined as fill level value of 0 (percent). The correction by a defined offset makes sense, for example, when the container geometry causes a dead volume to be formed over the container floor, from which a corresponding amount of fill substance cannot be emptied.

The zero value of the fill level defined according to the invention represents the lower limit of the fill level measurement range, wherein the measuring range can be defined either as an absolute measuring range or as a relative measuring range between 0% and 100%. In the case of an absolute measuring range, the upper limit can be defined by subtracting a defined absolute distance value from the, in given cases, corrected distance value, in order to form the fill level value of zero meters or zero percent. Accordingly, the extent of the measuring range is defined, in such case, by the absolute distance value.

When the fill level measurement range is defined as a relative measuring range, the 100% fill level value can be defined by multiplying the empty container measured distance value, or the distance value corrected by the offset, by a certain factor of maximum 1. Advantageously in such case, the factor is selected to be at least 0.75, for example, 0.95, such that the relative measuring range comprises a vertical, as great as possible, part of the container. Advantageous in the method of the invention is, on the whole, that no knowledge of the container geometry needs to be known for configuring the fill level measuring device for the container or the particular application.

The method of the invention can be implemented directly in the fill level measuring device, for example, or in an associated evaluation unit. In the case of the evaluation unit, it calculates the relative fill level value doing regular measurement operation based on the measured distance value. Advantageous in a direct implementing of the method in the fill level measuring device is that the method can be started by a switching unit of the fill level measuring device, such as, for example, by a switch or by an equivalent, display based input mask of the fill level measuring device. Another option, however, is that the method of the invention is initiated by a superordinated unit connected with the fill level measuring device, e.g., a superordinated unit such as a process control station or a cloud based control.

The terminology “unit” in the context of the invention means, in principle, any separate arrangement, or encapsulation, of electronic circuits, which are provided for the particular application, for example, for measurement signal processing or to serve as an interface. The unit can, thus, depending on application, comprise corresponding analog circuits for producing and processing analog signals. The unit can, however, also comprise digital circuits, such as FPGAs, microcontrollers or storage media in cooperation with corresponding programs. In such case, the program is designed to perform the necessary method steps, or to apply the needed computer operations. In this context, different electronic circuits of the unit can, in the sense of invention, potentially also access a shared physical memory, or be operated by means of the same physical, digital circuit. In such case, it does not matter whether different electronic circuits within the unit are arranged on a shared circuit board or on a plurality of interconnected circuit boards.

Besides the evaluation unit, travel time-based, fill level measuring devices for the method of the invention comprise:
a transmitting/receiving arrangement by means of which high frequency signals are transmittable to the fill substance, or container floor, and after reflection there receivable as received signals, and
a high frequency unit, which is designed to produce the high frequency signals of a defined travel time principle and based on the corresponding received signals to determine the distance to the fill substance surface, or to the floor of the container.

The design of these components is governed by the implemented travel time method. In particular, the transmitting/receiving arrangement can be designed either as an antenna, for example, a horn or flat antenna, or as a measuring probe. The transmitting/receiving arrangement is, for example, constructed as an antenna in the case in which the high frequency unit produces and processes the high frequency signals as radar signals especially according to the pulse travel time method or the FMCW method. Correspondingly, the transmitting/receiving arrangement is, moreover, constructed as an antenna, when the high frequency unit produces and processes the high frequency signals as ultrasonic signals especially according to the pulse travel time method. In contrast therewith, the transmitting/receiving arrangement is constructed as a rod- or cable-shaped measuring probe when the high frequency unit produces and processes the high frequency signals according to the TDR method.

The invention will now be explained in greater detail based on the appended drawing, the figures of which show as follows:

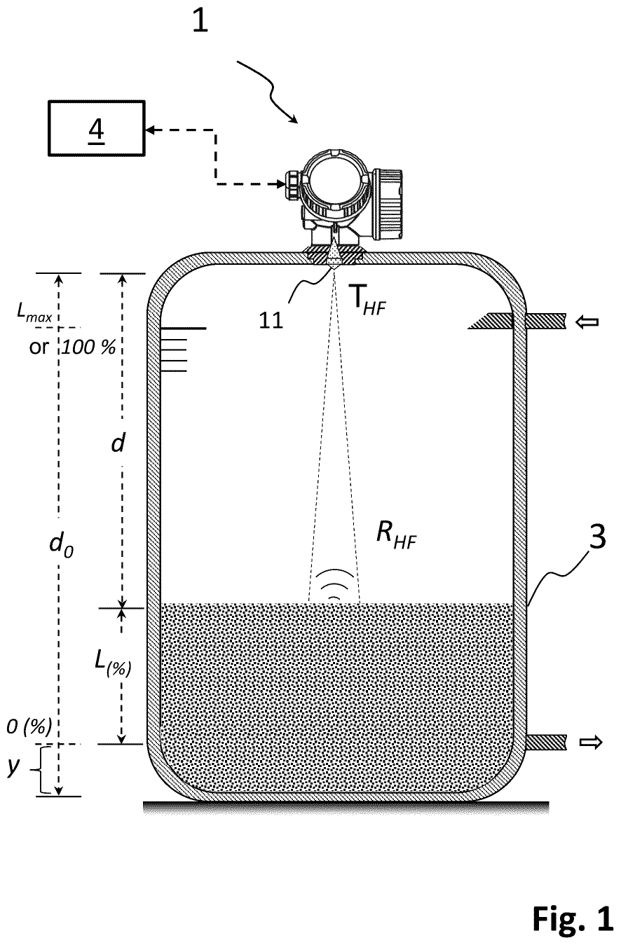

FIG. 1 a radar based, fill level measuring device located at a container; and

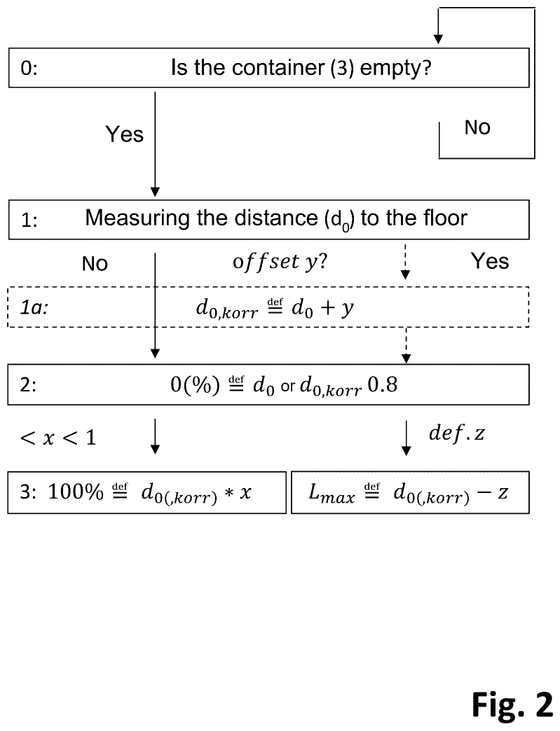

FIG. 2 a schematic view of the method of the invention.

For understanding the invention, FIG. 1 shows a container 3 containing a fill substance 2, whose fill level L is to be determined. In such case, the container 3 can, depending on type of fill substance 2 and depending on field of application, be more than 100 m high. In order to be able to determine the fill level L, a radar-based, fill level measuring device 1 is placed on the container 3 above the fill substance 2 at a distance d₀ from the floor of the container. Distance d₀ will vary, depending on container-type.

As a rule, the fill level measuring device 1 is connected via a suitable interface, such as, for example, “4-20 mA”, “PROFIBUS”, “HART”, or “Ethernet”, to a superordinated unit 4, such as, e.g., a local process-control station or a decentral server system. In this way, the measured fill level values L_{(%)} can be transferred, for example, in order to control possible ingoing and/or outgoing flows of the container 3. However, also other information concerning general operating state of the fill level measuring device 1 can be communicated in this way.

In the travel time measuring principle, the fill level measuring device 1 is secured in such a manner at an opening in an upper end region of the container 3 that transmitted radar signals T_{HF} can be transmitted via an antenna 11 into the container 3, and, after reflection on the fill substance surface, be received back as received radar signals R_{HF}. In such case, the radar signals T_{HF}, R_{HF} are produced and upon receipt processed within a high frequency unit of the fill level measuring device 1, for example, by means of the FMCW or the pulse travel time method. Instead of the antenna 11, it is, in contrast to the illustrated embodiment, also an option to apply as transmitting/receiving arrangement a measurement probe, which extends vertically downwards into the container 3 when the high frequency unit works according to the TDR method.

After reflection of the transmitted radar signals T_{HF} on the fill substance surface, the fill level measuring device 1 receives the reflected radar signals R_{HF} back, such as shown in FIG. 1. In such case, the resulting signal travel time t between transmitting and receiving the radar signals T_{HF}, R_{HF} obeys the formula,

$$t = \frac{2 * d}{c} ,$$

and is correspondingly proportional to the distance d between the fill level measuring device 1 and the surface of the fill substance 2. The variable “c” is the media-dependent, radar propagation velocity. In order to determine the signal travel time t, the FMCW or the pulse travel time method can be implemented in the fill level measuring device 1. Accordingly, the high frequency unit can comprise in the case of the FMCW method, for example, a corresponding phase control loop (“phase locked loop”). In the case of the pulse travel time method, the high frequency unit can operate based on the principle of pulse undersampling.

For example, after a corresponding calibration, the high frequency unit, thus the fill level measuring device 1, can, in turn, associate the measured signal travel time t with the corresponding distance d. Then the fill level measuring device 1 can pointwise determine the fill level L using

$$d = {d}_{0} - L ,$$

when the installed height d₀ of the fill level measuring device 1 at the container 3 is known.

The installed height d₀ can in practice, however, only be determined via a corresponding calibration or knowledge of container geometry. For this, for example, corresponding construction documentation of the particular container type can be accessed. Such geometric knowledge is additionally necessary, in order to be able to define the limits of the fill level measurement range appropriate for the container type. In such case, an absolute-determining of the fill level value L is, in given cases, not of interest, such that the limits of the measuring range define fill levels L_{%} of 100% and 0%, within which the currently measured fill level is provided as a relative value L_{%}. FIG. 2 illustrates methods of the invention for defining the fill level measurement range 0%-100% or its upper and lower limits, independently of container type and container geometry. The fill level measuring device 1 can, after performing the method as in FIG. 2, output the relative or absolute fill level value L_{(%)} using the earlier ascertained fill level measurement range 0%-100%, or 0-Lₘₐₓ.

For defining the fill level measurement range 0(%)-100(%), or Lₘₐₓ, the fill level measuring device 1 measures, analogously to conventional fill level measurement, the distance d₀ to the floor of the container 3 in the case of empty container 3. The measured distance value d₀, corresponding to signal travel time t₀/2, is then defined as the lower measuring range limit and, thus, either as an absolute fill level value L of zero meters, or as a relative fill level value L_{%} of zero percent (%). In order to exclude possible sediment or a lower dead volume below the outlet in the container 3 as a component of the usable amount of fill substance 2, it is according to the method alternatively also possible to define, individually, an absolute offset y according to

$$0 ( \% ) {=}^{def} {d}_{o , korr} = ( {d}_{0} - y ) ,$$

as a result of which the zero value of the relative fill level value L_{(%)} is defined slightly above the container floor, as illustrated in FIG. 1. In the case of a relative measuring range, its 100% value is defined by multiplying either the distance d₀ to the floor or the corrected distance to the floor d_{0,korr} by a defined factor x, according to

$$100 \% {=}^{def} {d}_{0} * x$$

$$or$$

$$100 \% {=}^{def} {d}_{o , korr} * x ,$$

in such case,

$$x \leq 1.$$

According to this definition of the invention for the upper and lower limits of the relative measuring range 0%-100%, the signal travel time t and the distance d measured during the regular measurement operation of the fill level measuring device 1 are, thus, exactly inversely proportional to the relative fill level value L_{%}, and vice versa. Thus, the fill level value L_{%} is given relative to the earlier ascertained measuring range limits.

In the case of a relatively defined measuring range 0%-100%, the factor x is selected advantageously as near as possible to 1, for example, x=0.95, in order that the fill level measurement range 0%-100% extends vertically, in turn, as much as possible for the complete interior of the container 3. As regards the upper measuring range limit of the relative fill level measurement range 0%-100%, thus, as regards the 100% value, it is, however, analogously to the possible offset of the lower measuring range limit, an option, so to choose the factor x that the 100% value is located at height equal to that of an inlet of the container 3, such as shown in FIG. 1.

Instead of defining the measuring range, or the upper limit 100%, relatively, it is alternatively also possible to define the upper limit Lₘₐₓ according to

$${L}_{max} {=}^{def} {d}_{o ( , korr )} - z$$

as an absolute value. In such case, the selected absolute distance value z corresponds to the desired, absolute extent of the measuring range 0 m-Lₘₐₓ and has, correspondingly, a metric or comparable units. In this connection, the absolute distance value z is to be so selected that the absolute measuring range 0 m-Lₘₐₓ, in turn, extends vertically as much as possible over the complete inner space of the particular type of container 3.

In the context of the invention, it is not important in which unit the method explained in FIG. 2 for defining the fill level measurement range 0(%)-100%/Lₘₐₓ is implemented. An option is, on the one hand, that the method is implemented in the fill level measuring device 1 or in an integrated evaluation unit. In such case, the fill level measuring device 1 can, after defining the fill level measurement range 0(%)-100%/Lₘₐₓ, output the relative fill level value L_{%} in the subsequent measurement operation based on the measured distance value d. In such case, the fill level measuring device 1 can output the fill level value L_{(%)}, for example, visually via a display, or as a digital value via the interface to the superordinated unit 4. For the case, in which the method is performed by the fill level measuring device 1, such can be equipped with a corresponding switch, button or the like, such that the performing the method of the invention is initiated thereby.

On the other hand, it is also an option, that the method of the invention is performed in the superordinated unit 4, according to which the superordinated unit 4 causes the measuring of the distance d₀ to the container floor at the fill level measuring device 1 and queries the distance value d₀ from the fill level measuring device. In such case, the fill level measuring device 1 needs in the subsequent, regular measurement operation only to transmit the measured distance value d to the superordinated unit 4, where then the fill level value L_{(%)} is determined based thereon. Independently of whether the absolute, or relative, fill level measurement range 0(%)-100%/Lₘₐₓ is determined in the fill level measuring device 1, or in the superordinated unit 4, there results according to the invention the advantage that the fill level measuring device 1 can be directly used at the container 3 without separate calibration after performing the method without having to know the geometry of the container.

### LIST OF REFERENCE CHARACTERS

1 fill level measuring device
2 fill substance
3 container
4 superordinated unit
11 antenna
d distance
d₀ installed height, distance from the container floor
L absolute fill level value
Lₘₐₓ upper limit of the absolute measuring range
L_{%} relative fill level value
R_{HF}, T_{HF} reflected-, transmitted radar signal
t signal travel time
x factor
y offset
z absolute distance value

1-11. (canceled)

12. A method for defining a fill level measurement range for travel time-based measuring of a relative or absolute fill level value of a fill substance in a container, the method comprising:
providing an empty container;
introducing a travel time-based, fill level measuring device at an upper end region of the container;
travel time-based measuring of a distance to a floor of the container; and
defining the fill level measurement range such that the fill level value of zero is defined for the empty container based on the measured distance value.

13. The method according to claim 12, wherein the measured distance value is set equal to the fill level value of zero, or wherein the measured distance value is corrected by a defined offset, and the corrected distance value is set equal to the fill level value of zero.

14. The method according to claim 12, wherein the fill level measurement range is defined as a relative measuring range, and
wherein the relative fill level value of 100% is defined based on the distance value measured for the empty container such that the distance value measured for the empty container is multiplied by a factor having a maximum value of 1, or
wherein the measured distance value is corrected by a defined offset, and the relative fill level value of 100% is defined based on the corrected distance value measured for the empty container such that the corrected distance value measured for the empty container is multiplied by a factor having a maximum value of 1.

15. The method according to claim 14, wherein the factor is at least 0.75.

16. The method according to claim 14, wherein the factor is at least 0.95.

17. The method according to claim 12, wherein the fill level measurement range is defined as an absolute measuring range, and wherein the upper limit value is defined such that an absolute distance value is subtracted from the distance value measured for the empty container or from the corrected distance value.

18. A fill level measuring device, comprising:
a transmitting/receiving arrangement adapted to transmit high frequency signals to a fill substance, or a container floor, and after reflection there, to receive the reflections as received signals;
a high frequency unit configured to:
produce the high frequency signals of a defined travel time principle, and
determine a distance to a surface of the fill substance, or to the container floor, based on the corresponding received signals; and
an evaluation unit configured to perform the method according to claim 12 and to determine and/or to output the fill level value in relation to the fill level measurement range based on the measured distance value.

19. The fill level measuring device according to claim 18, further comprising a switching unit, whose actuation initiates the performing of the method of claim 12.

20. The fill level measuring device according to claim 18, wherein the transmitting/receiving arrangement is an antenna or a measuring probe.

21. The fill level measuring device according to claim 18, wherein the transmitting/receiving arrangement is an antenna, and wherein the high frequency unit is configured to generate and to process the high frequency signals as radar signals according to the pulse travel time method or the frequency modulated continuous wave (FMCW) method.

22. The fill level measuring device according to claim 18, wherein the transmitting/receiving arrangement is an antenna, and wherein the high frequency unit is configured to generate and to process the high frequency signals as ultrasonic signals according to the pulse travel time method.

23. The fill level measuring device according to claim 18, wherein the transmitting/receiving arrangement is a measuring probe, and wherein the high frequency unit is configured to generate and to process the high frequency signals according to the time domain reflectometry (TDR) method.
